(19) United States
(12) Patent Application Publication
(10) Pub. No.: US 2026/0275862 A1
(43) Pub. Date: Sep. 17, 2026

(54) METHOD FOR OPTIMIZING ROCK LATERAL SAMPLING IN CARBONATE FORMATIONS

(71) Applicant: PETRÓLEO BRASILEIRO S.A. - PETROBRAS, RIO DE JANEIRO (BR)

(72) Inventors: Marcos Vinicius SUGUINO, Rio de Janeiro (BR); Luma Botelho de SOUZA, Rio de Janeiro (BR)

(73) Assignee: PETRÓLEO BRASILEIRO S.A. - PETROBRAS, RIO DE JANEIRO (BR)

(21) Appl. No.: 19/560,341

(22) Filed: Mar. 9, 2026

(30) Foreign Application Priority Data
Mar. 13, 2025 (BR) 1020250047888

(51) Int. Cl. E21B 49/00; G01V 1/50

(52) U.S. Cl. CPC E21B 49/00; G01V 1/50; G01V 2210/74

(57) ABSTRACT

Optimized method for rock lateral sampling in carbonate formations, reducing operational failures and lost time. The method classifies the samples based on the mechanical strength of the rock, determined by the UCS (Unconfined Compressive Strength) incorporating heterogeneities via the mega-giga-pores method, and on geological importance, considering the uncertainty of the reservoir parameters. The prioritization follows a structured sequence, where 70-90% of the low-risk samples are collected first, followed by 10-30% of the high-risk samples, ensuring greater efficiency and recovery. The approach allows for dynamic adjustments during the operation and can be applied to both wireline logging and Logging While Drilling (LWD), optimizing costs and increasing the reliability of the reservoir characterization.

### RELATED APPLICATION DATA

This application is based on and claims priority to Brazilian Application No. BR 10 2025 004788 8, filed on Mar. 13, 2025, the entire contents of which are incorporated herein by reference.

### FIELD OF THE INVENTION

The present invention pertains to the technical field of oil and gas exploration and production, more specifically in the planning and execution of rock lateral sampling operations in carbonate formations. The proposed method optimizes the sample acquisition, improving the operational efficiency and reducing costs and risks associated with the recovery of lateral samples.

### BACKGROUND OF THE INVENTION

Currently, rock lateral sampling in carbonate formations faces challenges due to the heterogeneity of these formations, which include natural fractures, vugs, and karstifications. Conventional methods use mineralogy and porosity parameters as proxies for rock strength, being effective in siliciclastic formations, but limited in the characterization of the carbonate formations.

In conventional approaches, there are cases where 5 logging runs were necessary to perform 127 sampling attempts, whereas, with optimized planning, the operation could have been performed in 3 runs. In addition, operational failures such as samples stuck in the drill bit or collection tube result in lost time and inefficiency in the operation.

### STATE OF THE ART

Document U.S. Pat. No. 9,097,821 B2 describes a computational method for the petrophysical classification of rock types in oil and gas reservoirs, focusing on carbonate formations. This method is based on the identification of a Data Scenario (DS) for the reservoir or field, from information such as well density, well log data, core data and production data. From the DS, multiple Depositional Rock Types (DRTs) are determined, which are defined based on depositional attributes. Next, diagenetic modifiers (DMs) or primary textures (PMs) are identified and associated with the DRTs. This data is used to categorize the reservoir into a Reservoir Type (RT), classified as Type I, Type II, or Type III, depending on the degree of diagenetic modification of the rocks. In addition, the method also involves identifying pore types using data from different sources, such as well logs, capillary pressure analyses, and core data. Based on the DRTs, DMs, and pore types, Petrophysical Rock Types (PRTs) are determined, characterized by specific petrophysical properties and validated by using core and dynamic data. These PRTs are used to construct 3D reservoir models, considering spatial interrelation rules.

Document US20160266274 A1 describes a method for identifying high-productivity areas, known as “sweet spots,” in unconventional hydrocarbon reservoirs, such as shale gas reservoirs. This process begins with obtaining rock samples from different reservoir locations, which are assessed using various techniques, including scanning electron microscopy (SEM), X-ray diffraction (XRD), porosity and permeability assessment, among others. The mechanical properties of the rocks, such as the modulus of elasticity (Young's modulus) and Poisson's ratio, are determined for each sample. These properties are used to infer geomechanical characteristics, such as rock strength, mineral composition, and potential for hydraulic fracturing. In addition, the variations in the values of compressional (Vp) and shear (Vs) wave velocities are analyzed to determine properties such as the fluid type, fluid pressure, and lithology, with the Vp/Vs ratio used as an additional indicator of potential production zones. The method also includes the microstructural characterization of rocks, which assesses aspects such as porosity, microcracks and chemical composition.

Document U.S. Pat. No. 10,816,440 B2 describes a method for estimating mechanical properties of rocks from samples of drill cuttings collected during horizontal well drilling, using an integration of mineral composition data with a library of mechanical properties derived from nearby vertical well cores. The process begins with the collection of samples of drill cuttings during drilling, which are corrected for displacement and associated with specific depths. The samples are analyzed to determine the percentages of silica, clay and carbonate, which are arranged in a ternary diagram representing the mineral composition. Based on these data, the samples are compared to a pre-existing library of mechanical rock properties, built from data from nearby vertical cores, which have been analyzed for composition and mechanical properties such as modulus of elasticity, Poisson's ratio, compressive strength and other characteristics. Based on this comparison, the mechanical properties are imputed to the samples of drill cuttings that have a composition similar to the core samples. The samples are grouped into compositional facies based on the proportions of silica, clay, and carbonate. These facies are then used to construct a continuous log of material properties along the well depth, relating the mineral composition and the imputed mechanical properties. The log also includes the uncertainties associated with the estimated properties.

Mega-pore size is understood to be between 0.4 cm and 25.6 cm, as shown in the work of Choquete, P. W.; Pray L. 1970. Geologic Nomenclature and Classification of Porosity in Sedimentary Carbonates. The American Association of Petroleum Geologists Bulletin. Vol. 5, pp. 207-250, and giga-pores are sizes larger than 25.6 cm, as presented in Menezes de Jesus, C.; Compan, A. L.; Surmas, R.; 2016. Permeability Estimation Using Ultrasonic Borehole Image Logs in Dual-Porosity Carbonate Reservoirs. In: Petrophysics, Vol. 57, pp. 620-637.

However, the present invention differs from the alternatives of the state of the art as it presents a structured method for optimizing the rock lateral sampling sequence, prioritizing samples with low risk of mechanical failure and high geological importance in the initial stages of the operation, based on the classification of the rock strength according to UCS (Unconfined Compressive Strength), incorporation of heterogeneities through mega-giga-pores, obtained from petrophysical and ultrasonic logs, determination of the sample importance, considering uncertainties in geological models, and planning of the sampling sequence prioritizing the low-risk samples (70-90% of the initial sampling) and, subsequently, the high-risk samples (10-30%).

### SUMMARY OF THE INVENTION

The present invention proposes a method for optimizing rock lateral sampling in carbonate formations comprising the steps of: (a) reception of petrophysical data and image logs obtained in logging runs; (b) calculation of the uniaxial compressive strength (UCS) of the rock based on petrophysical correlations that use the total porosity as input, which incorporates the extra-matrix porosity obtained by the mega-giga-pores method; (c) classification of the potential samples as low risk or high risk of breakage during the sampling operation, based on the comparison of the UCS with a predefined limit; (d) assessment of the importance of the sample for the reservoir characterization, considering the uncertainty of the geological model parameters at the sample depth; (e) generation of a sample prioritization list, in which the low-risk samples are prioritized in 70-90% of the attempts, followed by the high-risk samples, ordered according to their importance; (f) transmission of the prioritized list to the end user responsible for performing the rock lateral sampling; (g) execution of the sampling according to the prioritized list, which may be carried out in one or multiple runs, depending on the capacity of the sample collection tube.

### BRIEF DESCRIPTION OF THE DRAWINGS

The present invention will now be described with reference to the typical embodiments thereof and also with reference to the accompanying drawings, in which:

FIG. 1 illustrates the different types of partial samples, according to an embodiment of the present invention.

FIG. 2 illustrates a comparison between the run-in of whole samples and partial samples in a core tube, according to an embodiment of the present invention.

### DETAILED DESCRIPTION OF THE INVENTION

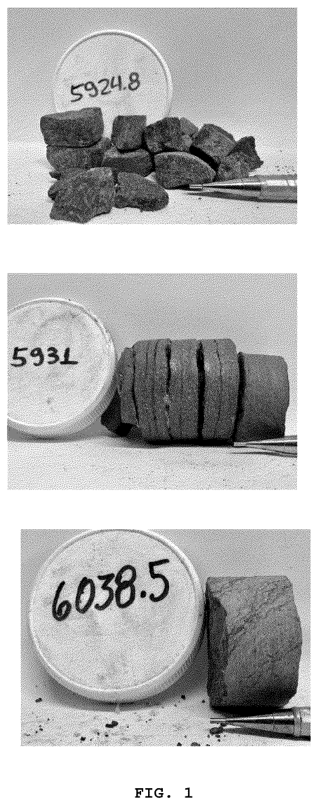

The time lost in rock lateral sampling operations occurs mainly due to the selection of non-ideal samples, resulting in unsuccessful attempts, recovery failures, and the need for multiple tool run-ins. In cases where fragmented (code 5924.8, first image), fractured (code 5931, second image) or partial (code 6038.5, third image) samples, as presented in FIG. 1, are selected without optimized criteria, there is a high risk of clogging the collection tube, packing of the core catcher ring and the sample becoming trapped inside the drill bit, leading to the interruption of the operation and a significant increase in the drilling time. The lack of adequate planning may require additional run-ins to recover essential samples, directly impacting the efficiency of the operation and increasing the operating costs.

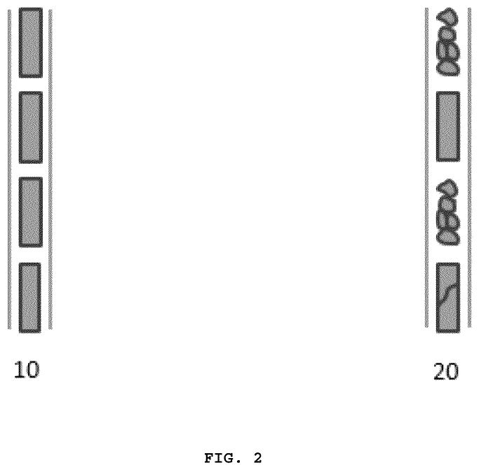

As can be seen in FIG. 2, whole samples (10) tend to run-in slowly to the bottom of the core tube, displacing the mud that was filling the same. In turn, the broken/fractured samples (20) do not only influence during sampling. They tend to have more friction with the core tube, and are generally pushed with each new sampling. With each new sample, there is a new opportunity to “jam” the core tube.

In this way, the invention proposes a structured method for optimizing the rock lateral sampling sequence, prioritizing samples with low risk of mechanical failure and high geological importance in the initial stages of the operation. The process begins with the reception of petrophysical data and image logs obtained in previous logging runs, which include ultrasonic image logs for identifying structural heterogeneities, such as fractures, vugs and karstifications, and density and porosity logs used to calculate the mechanical strength of the rock. This data is essential to ensure that the selection of the samples is done judiciously, minimizing operational risks and maximizing the sample recovery.

From these data, the uniaxial compressive strength (UCS) of the rock is calculated, incorporating the heterogeneities of the formation through the mega-giga-pores method. For this calculation, the matrix porosity of the formation is initially determined from the petrophysical logs, while the extra-matrix porosity is estimated by means of the interpretation of the ultrasonic imaging logs.

The sum of these two porosities generates the total porosity, which is then used to calculate the UCS by means of specific petrophysical correlations for carbonate formations. The UCS obtained is compared to a previously established critical limit, typically ranging between 600 and 1000 psi (4.137 to 6.895 MPa), allowing the classification of the samples as low or high risk of failure during the sampling operation. Samples with a UCS greater than the established limit are classified as low risk of breakage during the sampling operation.

After defining the risk of failure, each sample is also classified according to its importance for the reservoir characterization, considering the uncertainty associated with the parameters of the geological model at the depth in question. The geological model is built based on a conceptual model of the deposition and on data from analogous formations, well logs, and rock samples. Depending on the quantity and quality of the information, there may be greater or lesser reliability of the information. The importance of the sample is defined at three levels: high, medium, and low, where samples associated with regions with greater uncertainty are prioritized, while samples from well-characterized areas receive lower priority. This prioritization aims to ensure that, in case of operational failures, the most critical samples have already been collected.

Based on these classifications, an optimized sequence is generated for the acquisition of the lateral samples. Operational planning establishes that the low-risk samples should be acquired as a priority, comprising between 70 and 90% of the sequence, while the high-risk samples should be collected later, in an interval of 10 to 30% of the attempts. Within each risk category, the samples are ordered according to their geological importance, ensuring that those whose acquisition can significantly reduce the uncertainty of the geological model are prioritized.

The prioritized sample list is then delivered to the operational team responsible for performing the lateral sampling, ensuring that the defined sequence is followed to minimize failures and maximize the recovery rate. During the operation, the methodology can be applied in one or multiple runs, depending on the capacity of the sample collection tube. The possibility of dynamic adjustments during the execution allows the sequence to be reassessed if operational difficulties or failures in the sample recovery are identified.

In this way, the method for optimizing rock lateral sampling in carbonate formations comprises the following steps:
(a) reception of petrophysical data and image logs obtained in logging runs;
(b) calculation of the uniaxial compressive strength (UCS) of the rock based on petrophysical correlations that use the total porosity as input, enabling the incorporation of the extra-matrix porosity obtained by the mega-giga-pores method. Step (b) can be automated using a convolutional neural network;
(c) classification of the potential samples as low risk or high risk of breakage during the sampling operation, based on the comparison of the UCS with a predefined limit;
(d) assessment of the importance of the sample for the reservoir characterization, considering the uncertainty of the geological model parameters at the sample depth;
(e) generation of a sample prioritization list, in which the low-risk samples are prioritized in 70-90% of the attempts, followed by the high-risk samples, ordered according to their importance;
(f) transmission of the prioritized list to the end user responsible for performing the rock lateral sampling;
(g) execution of the sampling according to the prioritized list, which may be carried out in one or multiple runs, depending on the capacity of the sample collection tube.

Additionally, the methodology can be incorporated into an automated system, using optimization algorithms or convolutional neural networks to assist in identifying the heterogeneities of the carbonate formations and improve the sample selection.

The application of this method in real operations has already demonstrated significant improvements in the sampling efficiency. In well 8-BUZ-80D-RJS, for example, the methodology allowed the recovery of 48 whole samples, 5 partial samples and only 1 unrecovered sample, in a total of 54 attempts, without any catastrophic failures being recorded. The total operation time was reduced, minimizing the need for additional run-ins, resulting in a more efficient process with lower operating costs.

The invention enables its application in both wireline logging and logging while drilling (LWD). In addition, the calculation of the UCS considering the formation heterogeneities can be used for other applications within the oil and gas industry, such as determining rock strength in areas where completion packers or packers for formation testing will be installed. In this way, the proposed methodology not only improves the rock lateral sampling in carbonate formations, but also offers a valuable resource for various applications in the sector, contributing to a better understanding and characterization of the reservoirs.

What is claimed is:

1. A method for optimizing rock lateral sampling in carbonate formations, comprising the steps of:
(a) reception of petrophysical data and image logs obtained in logging runs;
(b) calculation of an uniaxial compressive strength (UCS) of the rock based on petrophysical correlations that use a total porosity as input, enabling incorporation of an extra-matrix porosity;
(c) classification of potential samples according to a risk of breakage during a sampling operation, based on a comparison of the UCS with a predefined limit;
(d) assessment of importance of the sample for the reservoir characterization, considering an uncertainty of geological model parameters at a sample depth;
(e) generation of a sample prioritization list, in which low-risk samples are prioritized in 70-90% of attempts, followed by high-risk samples, ordered according to importance;
(f) transmission of the sample prioritization list to an end user responsible for performing rock lateral sampling;
(g) execution of the sampling according to the sample prioritization list, which may be carried out in one or multiple runs, depending on a capacity of a sample collection tube.

2. The method according to claim 1, wherein the extra-matrix porosity is obtained by a mega-giga-pores method.

3. The method according to claim 1, wherein classification of the potential samples as low risk or high risk of breakage is based on a UCS limit in the range of 600 to 1000 psi (4.137 to 6.895 MPa).

4. The method according to claim 1, wherein the total porosity used in the UCS calculation is obtained by integrating the matrix porosity with the extra-matrix porosity identified by an ultrasonic imaging log method.

5. The method according to claim 1, wherein the importance of the sample is classified into three categories: high, medium and low, based on a degree of the uncertainty of the geological model parameters.

6. The method according to claim 2, wherein obtaining extra-matrix porosity through the mega-giga-pores method is automated by means of a convolutional neural network.

7. The method according to claim 1, wherein the method is applied in wireline logging or in logging while drilling (LWD).
